(19) United States
(12) Patent Application Publication
(10) Pub. No.: US 2010/0294951 A1
(43) Pub. Date: Nov. 25, 2010

(54) Sensitive gas-phase flourimeter at ambient pressure for nitrogen dioxide

(76) Inventors: Jeremy Parra, Beaverton, OR (US); Linda George, Portland, OR (US)

Correspondence Address: LUMEN PATENT FIRM, 350 Cambridge Avenue, Suite 100, PALO ALTO, CA, 94306, US

(21) Appl. No.: 12/800,752

(22) Filed: May 21, 2010

Related U.S. Application Data
(60) Provisional application No. 61/216,897, filed on May 22, 2009.

(51) Int. Cl. G01N 21/64; G01J 1/58

(52) U.S. Cl. 250/459.1; 250/458.1; 250/573; 250/227.11; 250/226

(57) ABSTRACT

An instrument detects an amount of a component of a sample gas by passing an excitation light through the sample gas at atmospheric pressure to produce fluorescence light from the component. The fluorescence light is discriminated using a sequence of multiple long pass interference filters to filter out the excitation light. The discriminated fluorescence light is then detected to produce a signal representative of the amount of the component in the sample gas. Preferably, the excitation light is continuously passed through the sample gas. In one embodiment, the gas flows through a cell having a parabolic reflector as an interior surface and a source of the excitation light at a focus of the parabolic reflector. In other embodiments, multiple components are detected in parallel using multiple sample cells and a fiber optic multiplexer to sequentially filter and detect the fluorescence light from each of the multiple sample cells.

### CROSS-REFERENCE TO RELATED APPLICATIONS

This application claims priority from U.S. Provisional Patent Application 61/216,897 filed May 22, 2009, which is incorporated herein by reference.

### FIELD OF THE INVENTION

The present invention relates generally to methods and devices for trace gas detection. More specifically, it relates to improvements of the detection of trace gasses such as NO₂ using laser induced fluorescence.

### BACKGROUND OF THE INVENTION

Laser induced fluorescence (LIF) is a common spectroscopic technique for trace gas detection in atmospheric monitoring and combustion sciences. One important application of LW is to the detection of nitrogen dioxide (NO₂) which is an important chemical species in the atmosphere and in combustion processes. Concerns about the harmful health effects of NO₂ and its role in forming deleterious atmospheric species have made it desirable to have sensitive measurements of NO₂. Fluorescence assay with gas expansion (FAGE) is one type of LW technique used to measure NO₂ in the atmosphere. Although FAGE achieves excellent sensitivities at short averaging times, it has the disadvantage that its sensitivity requires an expensive pumping system to lower the pressure of the air below ambient atmospheric pressure. The low pressure extends the fluorescence lifetime of the excited NO₂, and time-gated electronics are then used to discriminate against the scattered laser photons. The low pressure reduces the background “noise” arising from scattered photons resulting from the laser light interacting with air molecules, allowing the system to achieve sensitivities of less than 1 part per billion (ppb). When the main source of background noise is described by a Poisson distribution, the limit of detection (LOD), [NO₂]ₘᵢₙ, is given by the following equation:

$${[ {NO}_{2} ]}_{min} = \frac{( SNR )}{C} \sqrt{\frac{{S}_{bg}}{t}} , \qquad ( 1 )$$

where SNR is the signal to noise ratio (typically SNR=2), C is the sensitivity of the LW instrument (counts s⁻¹ ppb⁻¹) S_{bg} is the background signal (counts s⁻¹), and t is the integration time (s). The LOD improves as the square root of the background noise which goes down linearly with pressure. More importantly, a reduction in pressure decreases the number density of “bath” molecules which act to quench the excited molecule, thereby increasing the fluorescence lifetime, τ_{NO2}, which is given by

$${τ}_{NO 2} = \frac{1}{{k}_{r} + {\sum }_{i} {k}_{qi} {M}_{i}^{q}} , \qquad ( 2 )$$

where kᵣ is the radiative rate constant, k_{qi}, are the species dependent collisional quenching rate constants and Mᵢ^{q} are the number density of potential quenching molecules (e.g., O₂, N₂). The FAGE technique exploits this increase in fluorescence lifetime to avoid detecting scattered laser photons which arrive relatively instantaneously, by waiting sometime after the laser pulse to turn on the detector. Thus, using low pressure and time-gating, the fluorescence photons are measured against a very low background (e.g. 1.5 counts s⁻¹). However, to obtain this low background and high sensitivity, FAGE requires bulky pumping systems which increase instrument energy use, cost, and complexity. Further complexity is added by the time-gated electronics that are needed to discriminate the fluorescence signal from the background. It would be a significant advance in the art of LIF to overcome this and other limitations of known techniques.

### SUMMARY OF THE INVENTION

In one aspect, the present invention provides a high sensitivity LIF instrument for detecting an amount of a component in a sample gas at atmospheric pressure. Advantageously, the instrument does not need to operate at low pressure to achieve high sensitivity and thus does not require an expensive pump. In addition, the instrument is able to operate in continuous mode and does not require time gating circuitry to discriminate the fluorescence signal from the background.

In one embodiment, the invention provides a method of detecting an amount of a component in a sample gas. An excitation light is passed through the sample gas at atmospheric pressure to produce fluorescence light from the component. The fluorescence light is discriminated using a sequence of multiple long pass interference filters to filter out the excitation light. The discriminated fluorescence light is then detected to produce a signal representative of the amount of the component in the sample gas. The excitation light may be generated using a laser diode or light emitting diode. When applied to the detection of nitrogen dioxide, in some embodiments the excitation light preferably has a wavelength of less than 410 nm, more preferably a wavelength 403 nm to 409 nm, or most preferably a wavelength of 406.3 nm, while in other embodiments the excitation light preferably has a wavelength 398 nm to 450 nm, more preferably a wavelength 410 nm to 440 nm, or most preferably a wavelength of 413 or 435 nm. The fluorescence light from the nitrogen dioxide preferably has a lifetime less than 80 μS. The long pass filters each preferably achieve an optical density of 5 for wavelengths shorter than 440 nm and a transmittance greater than 90% for wavelengths in the range 448 to 900 nm. Preferably, the excitation light is continuously passed through the sample gas. In one embodiment, the gas flows through a cell having a parabolic reflector as an interior surface and a source of the excitation light at a focus of the parabolic reflector. In other embodiments, multiple components are detected in parallel using multiple sample cells and a fiber optic multiplexer to sequentially filter and detect the fluorescence light from each of the multiple sample cells.

### BRIEF DESCRIPTION OF THE DRAWINGS

FIG. 1 is a schematic diagram of a LW device with 90 degree off-axis detection of fluorescence according to one embodiment of the invention.

FIG. 2 is a detailed view of the detection portion of the device shown in FIG. 1.

FIG. 3A is a schematic for an embodiment of the invention which uses an LED as the excitation source and a parabolic mirror as a surface of the sample cell.

FIG. 3B is a schematic for a variant of the embodiment of FIG. 3A which uses a spherical mirror as a surface of the sample cell.

FIGS. 4A-C are schematic diagrams of an embodiment in which multiple components in a gas are detected in parallel using multiple sample cells and single filter and detector.

### DETAILED DESCRIPTION

Before describing embodiments of the present invention in detail, it is helpful to discuss some of the principles which allow high sensitivity at ambient pressures to be attained. The pressure dependence of a fluorescence signal may be calculated using the governing equations for an LIF signal (S_{NO2}) which is equal to the product of the excitation rate (E_{NO2}), the fluorescence efficiency (φ_{NO2}), and the collection efficiency (C_{NO2}) of the detection system:

S_{NO2}=C_{NO2}*E_{NO2}*φ_{NO2}. (3)

While excited NO₂ emits light over a wide spectrum (i.e., greater than 1000 nm), only a fraction of that light falls within the spectral window of a typical detector (200-900 nm). C_{NO2} represents the efficiency involved with collecting the fluorescence signal,

C_{NO2}=Ω*F*T, (4)

where Ω(0.038) is the solid angle intercepted by the collection optics for a typical off-axis design, F (0.7) is the fraction of fluorescence occurring within the spectral window of the detector and T (0.8) is the fraction of transmitted fluorescence through the optics (lens and filters). E_{NO2} is the rate at which NO₂ is excited with units of molecules s⁻¹, and can be expressed by:

E_{NO2}=c·l·∫φ(v)σ(v,temp,pressure)dv, (5)

where c is the number density of NO₂ (molecules cm⁻³), l (1 cm) is the length through which laser light interacts with the gas which is within the detector's view, φ(3×10¹⁵ photons s⁻¹ cm⁻²) is the laser flux and σ(about 6×10⁻¹⁹ cm² molecule⁻¹) is the absorption cross section of NO₂. φ_{NO2} is a function radiative rate constant for electronically excited NO₂ and the quenching rates:

$${Φ}_{NO 2} = \frac{{k}_{r}}{{k}_{r} + {\sum }_{i} {k}_{qi} {M}_{i}^{q}} \qquad ( 6 )$$

For high pressures (i.e., Σk_{qi}Mᵢ>>kᵣ) equation 6 simplifies to

$${Φ}_{NO 2} = \frac{{k}_{r}}{{K}_{Q} M} \qquad ( 7 )$$

where K_{Q} is a weighted average of the quenching rates which for dry air is ˜6×10⁻¹¹ cm³ molecule⁻¹ s⁻¹ and M is the total number density of air molecules (in molecules cm⁻³). The radiative rate constant for the fluorescence transition at λ_{excitation}=406.3 is kᵣ=2.6×10^{4 s}⁻¹ so that approximation in equation 7 can be made for pressures greater than 10 torr (i.e., M>3.26×10¹⁷ molecules cm⁻³). The number density of NO₂, c, and the total number density M from equation 7 are combined to yield

$${E}_{NO 2} * {Φ}_{NO 2} = \frac{{k}_{r}}{{K}_{Q}} \frac{c}{M} \cdot 𝓁 \cdot \int ϕ ( v ) σ ( v , temp , pressure ) d v \qquad ( 8 )$$

This result shows that the fluorescence signal is proportional to the mixing ratio of NO₂ and does not depend on the absolute number density of NO₂ for high pressures.

Surprisingly, the analysis above indicates that the fluorescence yield is higher at atmospheric pressure, is pressure-independent and the yield is even higher for transitions that have short lifetimes. In contrast, existing techniques of low-pressure LW, such as FAGE, succeed by using temporal gating to discriminate against laser photons and reduce background and desire a longer fluorescence lifetime. Embodiments of the present invention discriminate through the use of optical filters instead of temporal gating and prefer a shorter fluorescence lifetime.

Based on equation 4, the expected fluorescence signal is approximately 40 counts s⁻¹ ppb⁻¹. To achieve a LOD of 1 ppb NO₂ for a 60 second averaging time and a SNR of 2, the background is preferably less than 24,000 counts s⁻¹ (equation 1). Background reduction (S_{bg}≈10 000 counts s⁻¹) may be achieved through the use of high quality long-pass filters (e.g., O.D. >5 for λ=300-431 nm and % T>90 for λ=448-900 nm).

The zero pressure fluorescence lifetime, τ⁰, and the radiative rate constant are reciprocal so that equation 7 may be rewritten as:

$${Φ}_{NO 2} = \frac{1}{{τ}_{NO 2}^{0} * Q [ M ]} . \qquad ( 9 )$$

Therefore, a fluorescence transition with a shorter lifetime yields a greater fluorescence signal. NO₂ is spectroscopically complex leading to long lifetimes (˜100 μs) for most fluorescence transitions. The fluorescence lifetime is in the range of 28 to 42 μs for the 400-410 nm range as opposed to more than 80 μs for wavelengths used in other LIF instrumentation. Consequently, a factor of 2 increase in radiative rate constant may be obtained by exciting in the blue. Therefore, embodiments of the present invention use an excitation wavelength further into the blue, which also allows more of the red-shifted fluorescence to be within a detector spectral window of 200-900 nm.

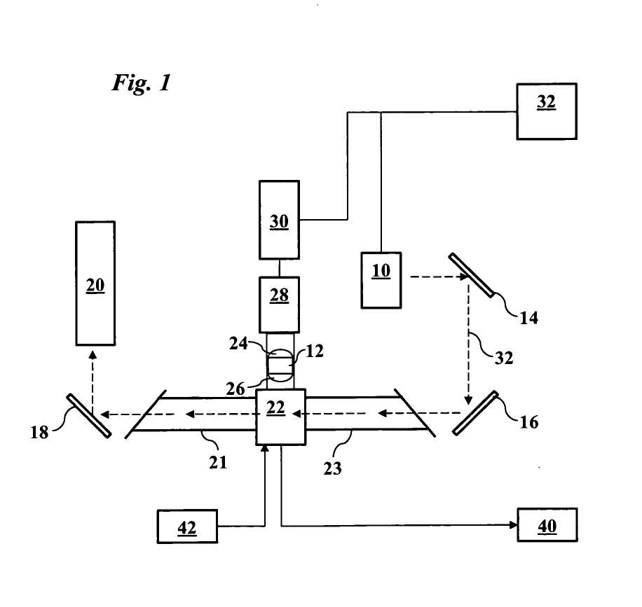

An apparatus according to one embodiment of the invention is shown in FIG. 1. This LW device has a 90 degree off-axis detection of fluorescence. It includes a compact excitation laser 10, steering mirrors 14, 16, 18, and beam dump 20. Also included is a detection system which includes sample cell 22 having side arms 21, 23, paired achromatic lenses 24, 26, long pass interference filter 12, and a photomultiplier (PMT) 28. The apparatus also includes a signal processing system which includes a discriminator and counter 30 and microcomputer 32. The apparatus notably does not have a high-volume pumping system or temporal gating circuits.

Laser 10 may be, for example, a temperature and current controlled 35 mW continuous-wave GaN semiconductor laser diode (Sanyo, DL 5146-152). This compact and relatively inexpensive laser diode is capable of being tuned over the range of 395-415 nm. In some embodiments of the invention designed for the detection of NO₂, the excitation light preferably has a wavelength less than 410 nm, more preferably between 403 nm and 409 nm, and most preferably tuned to 406.3 nm. In other embodiments of the invention designed for the detection of NO₂, the excitation light preferably has a wavelength 398 nm to 450 nm, more preferably a wavelength 410 nm to 440 nm, or most preferably a wavelength of 413 or 435 nm. Light 32 from laser 10 is directed by steering mirrors 14, 16 into sample cell 22 where it excites sample gas present in the cell. The beam exits cell 22 and is directed by mirror 18 into beam dump 20. Sample gas enters cell 22 after passing through polytetrafluoroethylene (PTFE) filter 42 and is drawn out of cell 22 by diaphram pump 40.

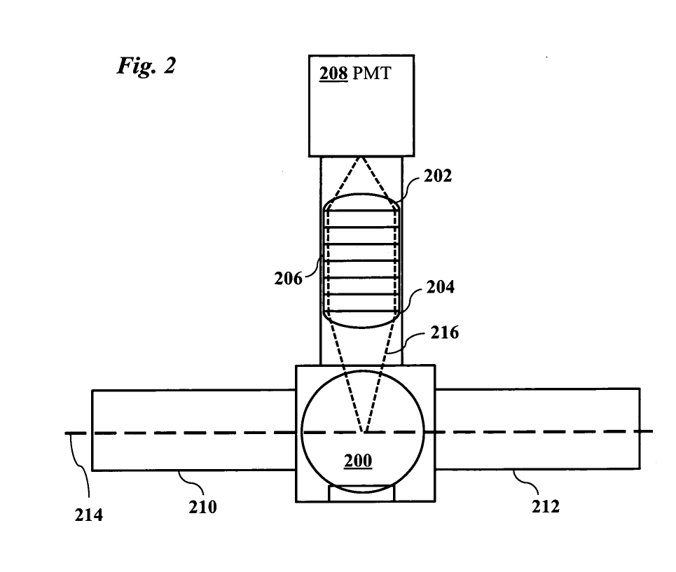

FIG. 2 is a detailed view of the detection system of FIG. 1. It includes sample cell 200, paired achromatic lenses 202 and 204, interference long pass filter 206, and photomultiplier 208. Excitation light 214 enters cell 200 where it interacts with the sample gas, producing fluorescence. The fluorescence light 216 follows the path shown through lens 204, long pass filter 206, lens 202, and then enters photomultiplier 208 where it is detected.

Fluorescence cell 200 is not required to be vacuum tight in order to make measurements. However, the cell is preferably air tight to facilitate gas sampling and constructed to shield extraneous environmental light. The fluorescence cell is preferably a cubic (4×4×4 cm) cell with two side arms 210, 212 for shielding extraneous light from entering the cell. Side arms 210, 212 preferably end with windows held at Brewster's angle where the excitation light enters and exits. The fluorescence signal 216 exits the cell 200 orthogonal to the excitation beam 214. Cell 200 also has two 0.635 cm diameter stainless steel gas ports (not shown) to which 0.635 cm PTFE tubing is connected for sample gas delivery and removal. Preferably these two ports are positioned on two opposite faces aligned on an axis orthogonal to the plane of the figure.

Excitation light 214 interacts with the sample gas in cell 200 to produce fluorescence light 216. The wavelength of the excitation light preferably is selected so that the fluorescence lifetime of the species being detected in the sample gas is less than 80 μs, thereby producing a stronger fluorescence signal than with longer lifetimes. The fluorescence signal 216 exits the cell 200 and is directed by lens 204 through long pass filter 206 and then focused upon photomultiplier 208 by lens 202. The two lenses 202, 204 are preferably 25 mm achromatic lenses with anti-reflection coatings and 30 mm focal lengths (Edmunds Optics, ACH 25×30 VIS-NIR). Positioned between the two lenses is long pass filter 206 preferably composed of four long-pass interference filters with cut-on wavelengths at 440 nm (Chroma tech., HQ440LP). These filters reject scattered photons from the excitation light and transmit photons from the fluorescence light. These filters each achieve an optical density of 5 for wavelengths shorter than 431 nm and a transmittance greater than 90% for wavelengths in the range 448 to 900 nm The focal point of the first lens 204 intersects the excitation beam 214 so that the rays of the fluorescence light 216 propagate along parallel paths through the long-pass filters and are focused by the second lens 202 onto the active surface of the photodetector 208.

Returning to FIG. 1, fluorescence photons are detected by photomultiplier tube (PMT) 28 with quantum efficiency above 10% to 900 nm (Burle electron tubes, C31034). The PMT is preferably kept at −25° C. in a thermoelectric cooler (EMI Gencom, FACT 50 MKIII). The signal from the PMT is fed into discriminator and counter 30 which includes a digital I/O module for sending the digital data to microcomputer 32 which executes data acquisition instructions. The discriminator (Phillips, Model 704) preferably has a pulse-pair resolution of 3.3 ns. Pulses from the discriminator are counted by a 100 MHz counter (Tennelec, TC531) 30, the BCD output of the counter is read by a digital I/O module (Measurement Computing USB-DI096/H) and then imported to microcomputer 32 via a universal serial bus (USB) port. Data acquisition instructions simultaneously record photon (counts s⁻¹) and analog signals (i.e., power and temperature) from the laser controlling system. Computer 32 is also used to control laser 10.

A small inexpensive diaphragm pump (Rietschel Thomas, Model 2107 capable of 46 lpm at 760 torr) 40 may be used to produce flow of ambient pressure sample gas through the tubing from an ambient rooftop intake manifold and through the sample cell 22. Prior to entering the chamber 22 the sample gas may be passed through a polytetrafluoroethylene filter (SKC, 47 mm) 42 with a 2 μm pore size to remove light-scattering particles. For background measurements, nitrogen dioxide can be removed from the gas flow by passing the sample gas through ferrous sulfate or by reducing nitrogen dioxide photolytically. Calibration of the LW instrument may be performed using standard gas calibration techniques using National Institute of Standards and Technology (NIST) gas standards or permeation tubes and dilution systems.

By operating the excitation light in continuous wave mode this system has the advantage of very low photon density, thereby significantly reducing the likelihood of two photon inferences. Other species which can photodissociate to NO₂ include HNO₃, N₂O₅, HNO₄, PAN and ClNO_{X}. However, because they have absorption cross sections 10 to 100,000 times smaller than that of NO₂, they will not interfere significantly at concentrations typically found in the atmosphere.

This embodiment provides a continuous-wave laser-diode LW-based approach for NO₂ detection that can be operated at atmospheric pressure. The use of high quality optical filters provides substantial discrimination against scattered laser photons without the use of time-gated electronics or expensive pumps to produce low pressure, thereby avoiding complexity and cost to conventional LIF instrumentation. This improvement allows operation at atmospheric pressure with a low-cost diaphragm sampling pump. The LIF instrument for NO₂ detection operates at atmospheric pressure and has a sensitivity of 2 ppb (SNR=2) with an averaging interval of 60 s. Those skilled in the art can appreciate that many variations may be made to the specific embodiment described. For example, the optical train may be optimized to potentially achieve sub-ppb sensitivities. Fiber optics can be used for the delivery of excitation light to the cell, and for the delivery of fluorescence light from the cell to the filters and photomultiplier. Tuning of the laser to move the wavelength of the excitation light in and out of the NO₂ absorption feature can be used to eliminate the need for FeSO₄ for background measurements. In addition to environmental applications, this system also has potential application for other fields where direct and non-intrusive measurements of NO₂ are needed, such as flame, combustion and surface chemistry.

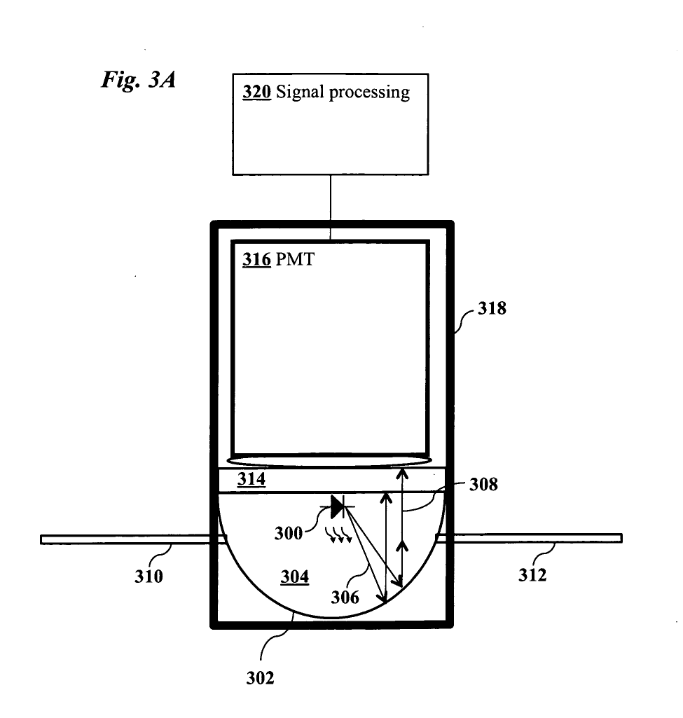

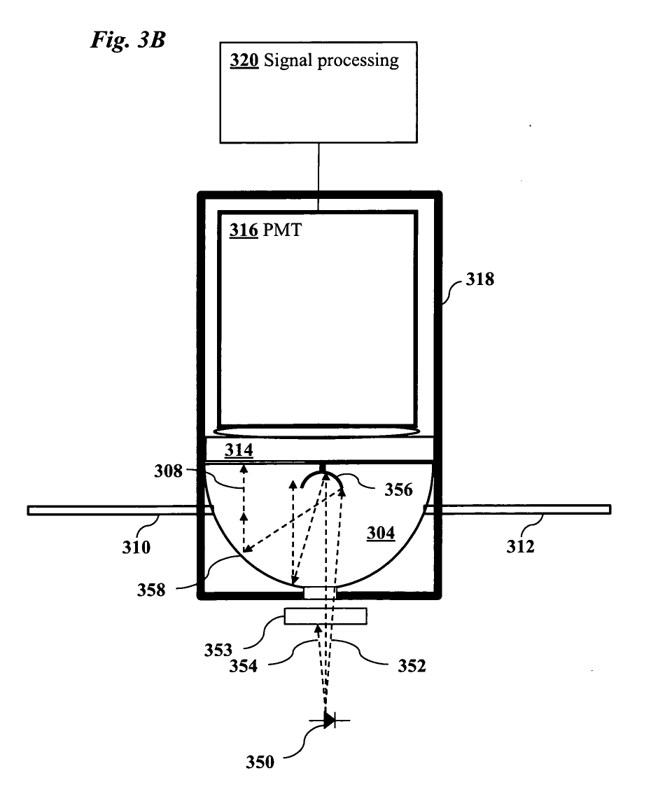

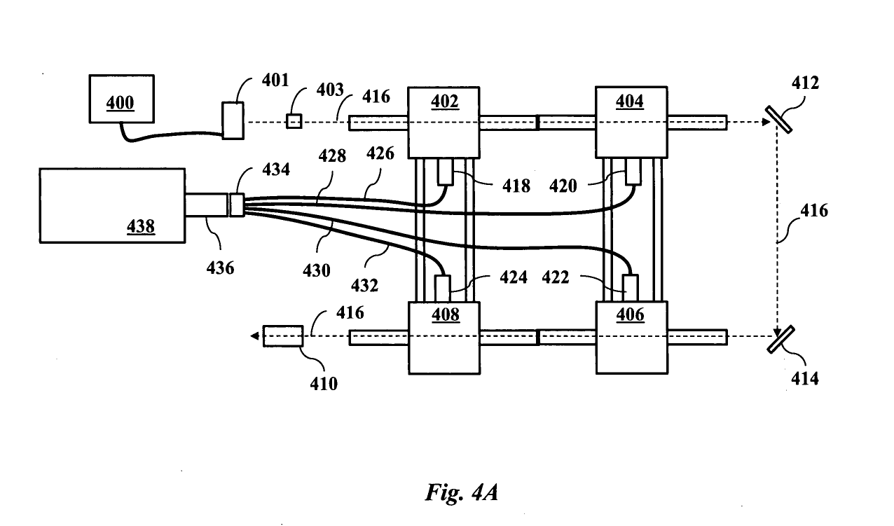

FIG. 3A is a schematic diagram of an apparatus according to a second embodiment of the invention. This embodiment is more compact, less expensive, and more sensitive. The excitation light source 300 is an LED with a peak emission wavelength preferably between 403 nm and 409 nm and power output of about 120 mW. The half intensity angle is 20 degrees. The LED 300 is positioned at the focus of a parabolic reflector 302, the inside of which forms the sample cell 304. The excitation light 306 interacts with sample gas in the cell 304 and produces fluorescence light 308. A mixture of fluorescence light 308 and excitation light 306 passes through long pass interference filter 314 which blocks the majority of the excitation light. Fluorescence light passing through filter 314 enters photomultiplier (PMT) 316 where it is detected and converted to an electrical signal that is processed by signal processing components 320, as in the prior embodiment. Sample gas is pumped into cell 304 via gas tube intake 310 and exits the opposite side of the cell via gas outlet 312. Excitation light from the LED interacts with the NO₂ present in the gas and causes it to fluoresce. A casing 318 which encloses the PMT and the sample cell serves to block ambient light and provide an air tight cell. This embodiment has higher sensitivity due the increase in excitation power. It also is simpler and less expensive than the prior embodiment.

FIG. 3B is a schematic for a variant of the embodiment of FIG. 3A. In this embodiment the LED 350 is positioned outside of the cell 304. The excitation light 352 passes through a band pass interference filter 353 which rejects unwanted wavelengths such as light 354 produced by the LED. The filtered excitation light then passes into the cell interior through a window in casing 318 and is reflected from a first spherical reflector 356 positioned in the cell and a second reflector 358 formed by a reflective interior surface of the sample cell wall. Reflector 356 is located at the focus of reflector 358. Although shown concave, in a variant design reflector 356 could alternatively be convex. As in the embodiment of FIG. 3A, the excitation light 352 interacts with the to compound of interest in the sample gas contained in the cell 304 to produce fluorescence light 308 which then passes through long pass filter 314 and into PMT 316 for analysis by signal processing 320. Sample gas is pumped into cell 304 via gas tube intake 310 and exits the opposite side of the cell via gas outlet 312.

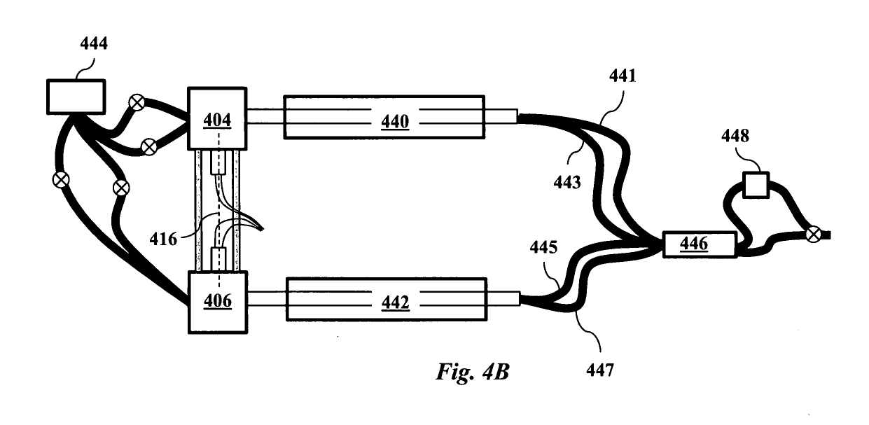

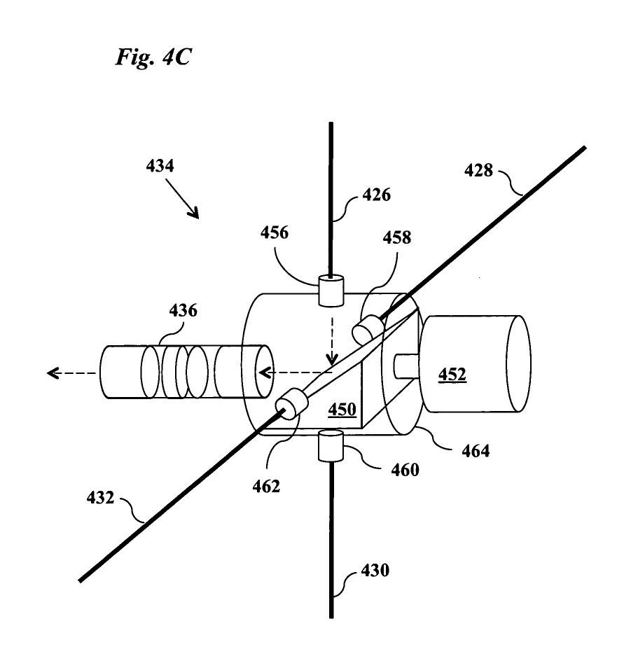

Embodiments of the invention can be utilized as a “backend” detector of an NO_{y} ambient monitor. Since this NO₂ detection technique does not require an expensive high-capacity pump, separate cells for each constituent of NO_{y} can be employed, thereby eliminating the complexity and potential chemical artifacts associated with switching between NO_{y} modes. For example, FIG. 4A illustrates an embodiment of the invention for a total NO_{y} detection instrument (where NO_{y} denotes a mixture of NO, NO₂, peroxyacyl nitrates (PAN), Alkyl Nitrates (AN), and nitric acid). Laser diode 401 with controller 400 produces an excitation beam 416 which passes through bandpass filter 403 and then propagates sequentially through four cells 402, 404, 406, 408 and into beam dump 410, directed by mirrors 412, 414. Cells 402, 404, 406, 408 are similar in design to that shown in FIG. 2, except that fluorescence light signals are collected at each fluorescence cell with respective fiber collection optics 418, 420, 422, 424 and transmitted via respective optical fibers 426, 428, 430, 432 to fiber optic multiplexer 434 and then into filter pack 436 which contains a pair of lenses and long pass filter similar to those in FIG. 2. The signal from filter pack 436 is then detected by PMT 438 and processed in an analogous manner as in previous embodiments.

Multiplexer 434 will now be described in detail in relation to FIG. 4C. Fibers 426, 428, 430, 432 enter multiplexer 434 through four respective ports 456, 458, 460, 462 positioned around the side of a cylindrical housing 464. Inside the housing is a right prism 450 with a mirrored surface on the hypotenuse. The face of the mirror is at 45 degrees to the end of the cylindrical housing. A stepper motor 452 is attached to the right prism through one end of the housing. The positions of the fiber optic ports 456, 458, 460, 462 correspond to the positions of the stepper motor 452 such that, for each position of the mirror 450, the light entering from one of the fibers 426, 428, 430, 432 is reflected off the mirrored surface of right mirror 450 and directed out of the end of the housing. It then passes through the filter pack 436 and into the PMT 438 (FIG. 4A). Using this multiplexer 434, as the mirror 450 rotates, the signals coming from the four fluorescence cells may be sampled sequentially using just a single filter pack and PMT. This design eliminates the cost, bulk, complexity and power requirements of 3 PMT/cooler systems and also minimizes the need for cross-channel calibrations in order to account for differences such as PMT quantum efficiencies and photon counting electronics.

FIG. 4B illustrates a side view of the apparatus of FIG. 4A. A diaphragm pump 444 draws ambient pressure gas for sampling in the four cells, such as cells 404 and 406, through four respective gas flow tubes 441, 443, 445, 447 originating from a common sampling and calibration manifold 446 and particulate filter 448. The separate tubes have respective quartz tube sections, such as sections 440 and 442, which may be heated to distinct predetermined temperatures. These quartz thermal dissociation flow tubes (˜1 m length, 1 cm internal diameter) are coupled to each of the four cells. Three flow tubes are temperature-controlled at approximately 200 C, 400 C, 600 C, respectively for thermal dissociation of PAN, AN and nitric acid measurements, respectively, using nichrome wire heating jackets and a custom-built controller circuit. The fourth tube, for ambient NO₂ measurement, is insulated but not heated. Thus, each of the three distinct species of interest may be detected by converting it by heat to NO₂ which is then measured to derive the amount of the original species of interest. Naturally, the transformation of species is not limited to heat and may employ various other well known transformation techniques, such as chemical reactions or light, as appropriate and suitable to the species of interest. The following list provides a few examples.

| | |
|---|---|
| 1. Nitrogen Dioxide (NO₂) | NO₂ + light [symbol] fluorescence signal |
| 2. Nitric Oxide (NO) | NO + Ozone [symbol] NO₂ |
| 3. Peroxyacyl Nitrate (PAN) | PAN + heat (200 C.) [symbol] NO₂ |
| 4. Alkyl Nitrates (AN) | AN + heat (400 C.) [symbol] NO₂ |
| 5. Nitric Acid(HNO₃) | HNO₃ + heat (600 C.) [symbol] NO₂ |
| 6. Nitrate (NO₃) | NO₃ + light [symbol] fluorescence signal |
| 7. OH | OH + light [symbol] fluorescence signal |
| 8. SO₂ | SO₂ + light [symbol] fluorescence signal |
| 9. Formaldehyde (HCHO) | HCHO + light [symbol] fluorescence signal |

Although the above embodiments have been described with reference to the measurement of NO₂ in the atmosphere, those skilled in the art will appreciate from the above description that the principles of the invention are not limited to NO₂ measurements. Any atmospheric gas species which is excited in the visible and fluoresces in the visible is a candidate for the ambient pressure fluorimeter designs in accordance with the teachings of the present invention. It is only a matter of selecting the appropriate excitation source wavelength and interference filters.

1. A method of detecting an amount of a component in a sample gas, the method comprising:
passing an excitation light through the sample gas to produce fluorescence light from the component, wherein the sample gas is at atmospheric pressure;
discriminating the fluorescence light using a sequence of multiple long pass interference filters to filter out the excitation light; and
detecting the discriminated fluorescence light to produce a signal representative of the amount of the component in the sample gas.

2. The method of claim 1 wherein the component is nitrogen dioxide, and wherein the long pass filters each achieve an optical density of 5 for wavelengths shorter than 440 nm and a transmittance greater than 90% for wavelengths in the range 448-900 nm.

3. The method of claim 1 wherein the component is nitrogen dioxide and wherein the excitation light has a wavelength of less than 410 nm and more than 400 nm.

4. The method of claim 1 wherein the component is nitrogen dioxide and wherein the excitation light has a wavelength 403 nm to 409 nm.

5. The method of claim 1 wherein the component is nitrogen dioxide and wherein the excitation light has a wavelength of 406.3 nm.

6. The method of claim 1 wherein the component is nitrogen dioxide and wherein the fluorescence light from the component has a lifetime less than 80 μs.

7. The method of claim 1 further comprising generating the excitation light using a light emitting diode.

8. The method of claim 1 further comprising generating the excitation light using compact GaN laser diode.

9. The method of claim 1 wherein the excitation light is continuously passed through the sample gas.

10. The method of claim 1 wherein the component is selected from the group consisting of nitrogen dioxide, nitric oxide, peroxyacyl nitrate, alkyl nitrates, nitric acid, nitrate, sulfur dioxide, formaldehyde, and hydroxyl.

11. The method of claim 1 wherein passing the excitation light through the sample gas comprises flowing the gas through a cell having a concave reflector as an interior surface and reflecting the excitation light within the cell from the concave reflector.

12. The method of claim 11 further comprising generating the excitation light inside the cell at a focus of the concave reflector.

13. The method of claim 11 further comprising generating the excitation light outside the cell.

14. The method of claim 1 further comprising generating the excitation light outside a cell containing the sample gas and directing the excitation light into the cell.

15. The method of claim 1 further comprising directing the fluorescence light through an optical fiber.

16. The method of claim 1 further comprising passing the excitation light through multiple sample cells containing the sample gas for detecting different constituents of NO_{y}.

17. The method of claim 1 further comprising passing the sample gas through multiple temperature-controlled thermal dissociation flow tubes.

18. An apparatus for detecting an amount of a component in a sample gas, the apparatus comprising:
a light source generating an excitation light at a wavelength that causes fluorescence in the component;
a sample cell having an intake for the sample gas and output for the sample gas;
optics for directing the excitation light through the interior of the sample cell;
a sequence of multiple long pass interference filters optically coupled to the sample cell for discriminating fluorescence light produced by the component from the excitation light; and
a photodetector optically coupled to the long pass filter for converting the discriminated fluorescence light to a signal representative of the amount of the component.

19. The apparatus of claim 18 wherein the mirror is a concave reflector forming an interior surface of the sample cell, wherein the light source is a light emitting diode positioned within the sample cell at a focus of the parabolic reflector.

20. The apparatus of claim 18 wherein the long pass filters each achieve an optical density of 5 for wavelengths shorter than 431 nm and a transmittance greater than 90% for wavelengths in the range 448-900 nm.

21. The apparatus of claim 18 wherein the light source is a compact GaN laser diode.

22. The apparatus of claim 18 further comprising multiple sample cells having multiple corresponding intakes for the sample gas and multiple corresponding outputs for the sample gas.

23. The apparatus of claim 18 further comprising multiple temperature-controlled thermal dissociation flow tubes.
